(19) United States
(12) Patent Application Publication
(10) Pub. No.: US 2022/0229881 A1
(43) Pub. Date: Jul. 21, 2022

(54) Method and Device for Processing a Sensor Signal

(71) Applicant: Robert Bosch GmbH, Stuttgart (DE)

(72) Inventor: Jochen Hahn, Nufringen (DE)

(21) Appl. No.: 17/614,811

(22) PCT Filed: May 18, 2020
(86) PCT No.: PCT/EP2020/063820

§ 371 Date: Nov. 29, 2021

(30) Foreign Application Priority Data
May 31, 2019 (DE) 10 2019 208 002.2

(51) Int. Cl. G06F 17/14

(52) U.S. Cl. CPC G06F 17/142

(57) ABSTRACT

The disclosure relates to a method for processing a sensor signal. The method has a step of determining complex rotational factors for a fast Fourier transform. The complex rotational factors are determined using a processing rule, at least one sub-quantity of complex rotational factors, which are kept available, of a total quantity of complex rotational factors, which are kept available and are stored in a non-volatile storage unit, and at least one signal property which is derived from the sensor signal. The method also has a step of carrying out the fast Fourier transform on the sensor signal using the determined complex rotational factors in order to provide a processed version of the sensor signal.

### PRIOR ART

The invention is based on an apparatus or a method of the generic type in the independent claims. The subject matter of the present invention also relates to a computer program.

By way of example, a calculation of a discrete Fourier transform is known, in which a method for the fast Fourier transform for sequences of values of length N=2^{M}, where M is a positive integer, can be implemented. An objective of low memory requirements can also be realized in the case of a fast Fourier transform by means of a processor, as is disclosed in CN101083643A for example.

### DISCLOSURE OF THE INVENTION

Against this background, the approach presented here is used to present a method, further an apparatus which uses this method, and finally a corresponding computer program according to the main claims. Advantageous developments and improvements of the apparatus specified in the independent claim are rendered possible by the measures listed in the dependent claims.

According to embodiments, a method and an apparatus for reducing power requirements in the case of a fast Fourier transform (FFT) for calculating a discrete Fourier transform on computing cores or digital signal processors can be provided, in particular for processing a sensor signal. In this case, it is possible for example to realize, in an optimized fashion, a calculation of the Fourier transform and a calculation of the inverse transform for purely real-valued signals in the time domain and for complex-valued signals on microcontrollers connected to volatile and nonvolatile memory. In particular, in this case, values or signal values of a sequence can be transformed from an original domain to a target domain and transformed from a given representation of a sequence in the target domain back to the original domain. By dividing the data to be used for the fast Fourier transform into changeable data and unchanging data, these can be stored separately in a memory region for changeable data, a volatile memory, and a memory region for unchanging data, a nonvolatile memory. Advantageously, more than one objective for signal processing, in particular, can be optimized according to embodiments, for example a minimization of a criterion such as computational outlay, code size, variability, etc., wherein it is possible to minimize requirements in respect of computational outlay, memory requirements for program code, changeable data and constant data, and variability taking account of conditions and limitations of embedded systems, and hence it is possible to obtain a solution that is advantageous for an overall system. In this case, processing of a sensor signal can be implemented in particular with minimal overall outlay in relation to power consumption and use of memory and area for a system at least with a computing core connected to volatile and nonvolatile memory. Advantageously, it is possible to implement for example a fast Fourier transform with a minimum power consumption on computing cores or digital signal processors, wherein it is possible to implement a minimization of memory accesses and computing cycles, and a use of memory for changeable data in relation to memory for unchanging or constant data. Further, particularly in the case of implementations in integrated circuits (ASICs, application-specific integrated circuits) or further integrated circuits, it is possible to minimize an effectively required area for the transformations. The signal processing presented here can be suitable for example for computing cores or digital signal processors connected to volatile and nonvolatile memory, for the purposes of calculating the discrete Fourier transform from the original domain to the target domain or the inverse transformation from the target domain to the original domain.

A method for processing a sensor signal is presented, the method including the following steps:

determining complex twiddle factors for a fast Fourier transform, wherein the complex twiddle factors is determined using a processing rule, at least a subset of available complex twiddle factors of an overall set of available complex twiddle factors stored in a nonvolatile memory or a volatile memory, and at least one configuration derived from a property of the sensor signal, and

performing the fast Fourier transform on the sensor signal using the determined complex twiddle factors in order to provide a processed version of the sensor signal.

By way of example, this method can be implemented in software or hardware or in a mixed form of software and hardware, for example in an apparatus or a controller. A sequence of signal values can be transformed from an original domain to a target domain by means of the fast Fourier transform. If the original domain is the time domain, then the range is the frequency domain. If the original domain is the frequency domain, then the range is the time domain. The overall set of available complex twiddle factors can arise from a maximum length sequence of signal values which is required when processing the sensor signal. The nonvolatile memory can also be referred to as permanent memory or persistent memory. The nonvolatile memory can be, for example, at least one semiconductor memory component, such as an EPROM, EEPROM or flash memory, or a nonvolatile random-access memory (NVRAM). Within the determination step it is possible to access the overall set of available complex twiddle factors stored in the nonvolatile memory or to access this for reading the subset into the nonvolatile memory.

According to an embodiment, a processing rule can be used in the determination step, the rule, for the purposes of determining complex twiddle factors according to the relationship

$${W}_{N}^{p} = cos ( 2 π \frac{p}{N} ) + i \cdot sin ( 2 \frac{p}{N} )$$

for a fast Fourier transform of a sequence [symbol] _{N} of possible values of the sensor signal with a maximum required length Nₘₐₓ=2^{M}^{ₘₐₓ}, where M is a positive integer, using the overall set of

$$\frac{{N}_{max}}{2}$$

available complex twiddle factors W_{N}_{ₘₐₓ}^{p}, p=0, . . . ,

$$\frac{{N}_{max}}{2} - 1 ,$$

to facilitate for sequences [symbol] _{R} of actual values of the sensor signal of length R=Nₘₐₓ·2^{-M} the determination of the

$$\frac{R}{2}$$

complex twiddle factors W_{R}^{p}, p=0, . . . ,

$$\frac{R}{2} - 1 ,$$

from the Nₘₐₓ/2 available complex twiddle factors W_{N}_{ₘₛₓ}^{p}, p=0, . . . ,

$$\frac{{N}_{max}}{2} - 1 ,$$

according to the relationship

$${W}_{R}^{p} = {W}_{{N}_{max}}^{p \frac{{N}_{max}}{R}} .$$

Such an embodiment offers the advantage that computational outlay and power consumption can be reduced.

Additionally, the method can include a step of storing the overall set of available complex twiddle factors in the nonvolatile memory or volatile memory. Here, the storage step can be carried out before the determination step. The storage step can be carried out once or at least once. Such an embodiment offers the advantage of rendering it possible to reduce storage space and a required footprint for integrated circuits or electronic components in addition to a reduction in the computational outlay and the power consumption.

Further, in the performing step the fast Fourier transform can be a transformation from the time domain to the frequency domain. In this case, the sensor signal can be readable from an interface to a sensor. Here, the processed version of the sensor signal can contain a discrete Fourier transform. Such an embodiment offers the advantage of facilitating a reliable and accurate signal analysis or signal evaluation of the sensor signal.

Moreover, in the performing step the fast Fourier transform can be an inverse transformation from the frequency domain to the time domain. In this case, the sensor signal can represent a Fourier transform of the sensor signal. Here, the processed version of the sensor signal can represent an inverse transformation with conjugate coefficients. Such an embodiment offers the advantage of being able to efficiently realize a signal analysis, a signal interpretation and further processing of the sensor signal in relation to computational outlay, signal-to-noise ratio and latency.

According to an embodiment, an increment for access to the available complex twiddle factors at the runtime of the method can be set in the determination step. Such an embodiment offers the advantage of not needing to calculate the required factors at runtime, of being able to create a subset of the complex factors in a volatile memory and, additionally or alternatively, of not needing to keep available multiple examples of twiddle factors for different lengths of sequences, and so it is possible to save storage space or area of integrated circuits.

Additionally, the complex twiddle factors can be determined from the available complex twiddle factors in the determination step by means of an interpolation and, additionally or alternatively, by using geometric identities. Such an embodiment offers the advantage of being able to carry out transformations and, additionally or alternatively, inverse transformations in efficient, fast and energy-saving fashion.

The approach presented here further develops an apparatus designed to carry out, drive or implement the steps of a variant of a method presented here in corresponding devices. The object underlying the invention can also be achieved quickly and efficiently by this embodiment variant of the invention in the form of an apparatus.

To this end, the apparatus can comprise at least one computing unit for processing signals or data, at least one memory unit for storing the signals or data, at least one interface to a sensor or an actuator for reading sensor signals from the sensor or for outputting data signals or control signals to the actuator, and/or at least one communications interface for reading or outputting data, which are embedded in a communications protocol. By way of example, the computing unit can be a signal processor, a digital signal processor, a microcontroller or the like, wherein the memory unit can be a flash memory, an EEPROM or a magnetic memory unit. The communications interface can be embodied to read or output data in wireless and/or wired fashion, wherein a communications interface, which can read or output wired data, can read these data for example in electrical or optical fashion from a corresponding data transfer line or output said data into a corresponding data transfer line.

In the present case, an apparatus can be understood to mean an electrical appliance which processes sensor signals and outputs control signals and/or data signals on the basis thereof. The apparatus can comprise an interface which may be embodied in terms of hardware and/or software. In the case of an embodiment in terms of hardware, the interfaces can be for example part of a so-called system ASIC, which contains very different functions of the apparatus. However, it is also possible for the interfaces to be dedicated integrated circuits or at least partly to consist of discrete component parts. In the case of an embodiment in terms of software, the interfaces can be software modules which for example are present in addition to other software modules on a microcontroller.

A computer program product or computer program having program code which may be stored on a machine-readable medium or storage medium, such as a semiconductor memory, a hard drive space or an optical memory, and which is used to carry out, implement and/or drive the steps of the method according to any one of the above-described embodiments is also advantageous, particularly if the program product or program is executed on a computer or an apparatus.

Exemplary embodiments of the approach presented here are displayed in the drawings and explained in more detail in the subsequent description. In detail:

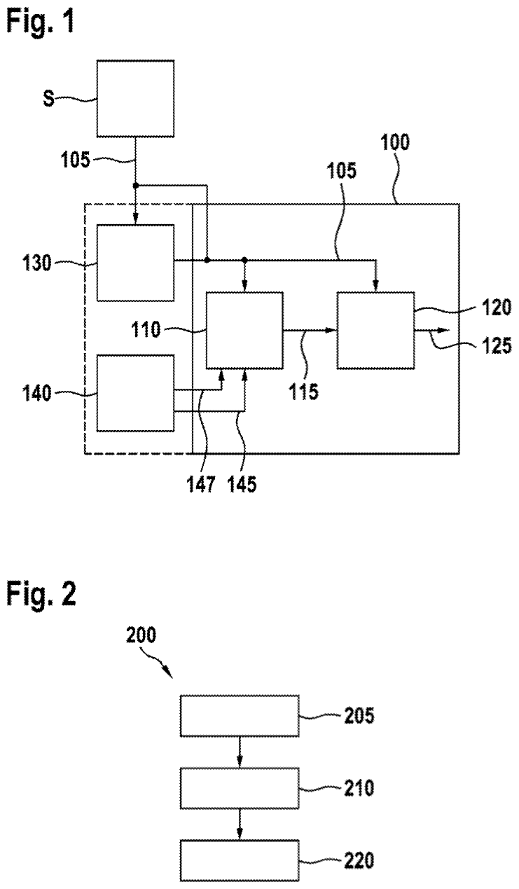

FIG. 1 shows a schematic illustration of an apparatus according to an exemplary embodiment;

FIG. 2 shows a flowchart of a processing method according to an exemplary embodiment;

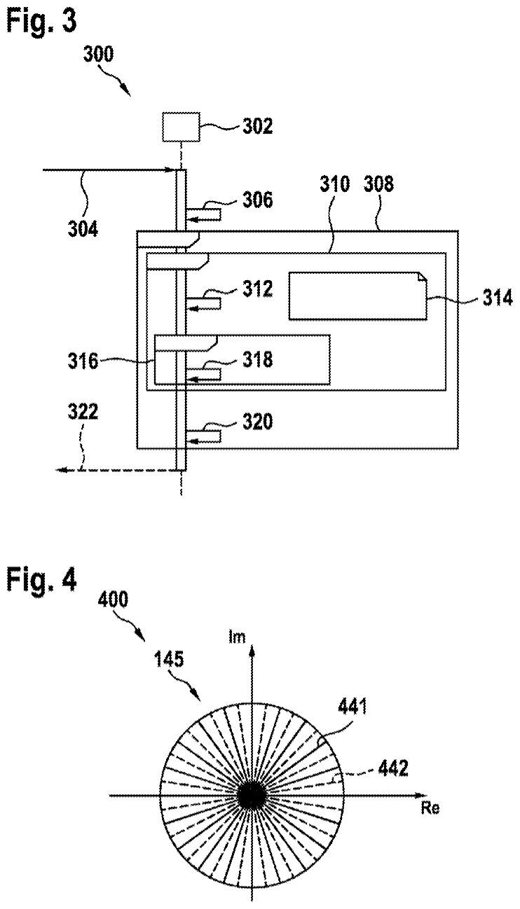

FIG. 3 shows a schematic flow diagram of a process according to an exemplary embodiment; and

FIG. 4 shows a schematic diagram for twiddle factors according to an exemplary embodiment.

In the following description of expedient exemplary embodiments of the present invention, the same or similar reference signs are used for the elements which are illustrated in the various figures and which have a similar effect, with a repeated description of these elements being dispensed with.

FIG. 1 shows a schematic illustration of an apparatus 100 according to an exemplary embodiment. The apparatus 100 can also be referred to as processing apparatus 100. The apparatus 100 is designed to process a sensor signal 105. The apparatus 100 is configured as a computing core, a digital signal processor or the like, or is configured as a part of a computing core, a digital signal processor or the like. The sensor signal 105 represents a signal which is provided by a sensor S and which represents a captured measurement variable. By way of example, the sensor S can be a microphone, an inertial measurement unit (IMU) or any other type of one-dimensional or multi-dimensional capture device.

The apparatus 100 comprises a determination device 110 and a performing device 120. The determination device 110 is designed to determine complex twiddle factors 115 for a fast Fourier transform. In this case, the determination device 110 is designed to determine the complex twiddle factors 115 using a processing rule 147, at least a subset of available complex twiddle factors 145 of an overall set of available complex twiddle factors 145 stored in a nonvolatile memory 140, and at least one configuration or signal property derived from the sensor signal 105. To this end, the determination device 110 is designed to read the sensor signal 105. Here, the determination device 110 is designed to read the sensor signal 105 from the sensor S or from any other device connected with signal transfer capabilities to the sensor S, in particular from a volatile memory 130. Further, the determination device 110 is designed to read available complex twiddle factors 145 and a processing rule 147 from a nonvolatile memory 140. Moreover, the determination device 110 is designed to derive at least one signal property from the sensor signal 105 or to read at least one signal property derived from the sensor signal 105. A further option consists in 110 storing new twiddle factors in 130 instead of the predetermined values in 140 such that this allows transformations and inverse transformations of greater lengths to be calculated.

In this context, it should be observed that, as a rule, the length of an FFT is a configuration. There are options for choosing the length of the FFT on the basis of an analysis of the signal such that desired insights about the signal can be obtained. By way of example, it is possible to determine the maximum sampling rate or the spacing between adjacent frequencies whose signal amplitude should be determined. An FFT now provides the complex amplitude for discrete frequencies such that an interpolation can be calculated in the case of a sufficiently fine representation in the frequency domain.

The performing device 120 is designed to perform the fast Fourier transform on the sensor signal 105 using the complex twiddle factors 115 determined by means of the determination device 110. Here, the performing device 120 is designed to generate and provide a processed version of the sensor signal 105 in the form of a processed sensor signal 125 using the sensor signal 105 and the complex twiddle factors 115 determined by means of the determination device 110.

At least the determination device 110 is designed to access the nonvolatile memory 140. The available complex twiddle factors 145 and the processing rule 147 are stored in the nonvolatile memory 140. Additionally, at least the determination device 110 is designed to access the volatile memory 130 by virtue of the sensor signal 105 being capable of being buffer stored.

According to an exemplary embodiment, the volatile memory 130 and/or the nonvolatile memory 140 is/are designed as part of the apparatus 100. In this case, the volatile memory 130 and the nonvolatile memory 140 are connected with signal transfer capabilities to the determination device 110 and/or to the performing device 120.

The processing rule 147 represents program code for carrying out the determination of the complex twiddle factors 115 for the fast Fourier transform. According to an exemplary embodiment, the determination device 110 is designed to use a processing rule 147 which, for the purposes of determining complex twiddle factors 115 according to the relationship

$${W}_{N}^{p} = cos ( 2 \frac{p}{N} ) + i \cdot sin ( 2 π \frac{p}{N} )$$

for a fast Fourier transform of a sequence [symbol] _{N} of possible values of the sensor signal 105 with a maximum required length Nₘₐₓ=2^{M}^{ₘₐₓ}, where M is a positive integer, uses the overall set of

$$\frac{{N}_{max}}{2}$$

available complex twiddle factors 145 W_{N}_{ₘₐₓ}^{p}, p=0, . . . ,

$$\frac{{N}_{max}}{2} - 1 ,$$

to facilitate or cause for sequences [symbol] _{R} of actual values of the sensor signal 105 of length R=Nₘₐₓ·2^{-M} the determination of the

$$\frac{R}{2}$$

complex twiddle factors 115 or W_{R}^{p}, p=0, . . . ,

$$\frac{R}{2} - 1 ,$$

from the

$$\frac{{N}_{max}}{2}$$

available complex twiddle factors 145 or W_{N}_{ₘₐₓ}^{p}, p=0, . . .

$$\frac{{N}_{max}}{2} - 1 ,$$

according to the relationship

$${W}_{R}^{p} = {W}_{{N}_{max}}^{p \frac{{N}_{max}}{R}} .$$

According to an exemplary embodiment, the determination device 110 is also designed to set an increment for access to the available complex twiddle factors 145 at the runtime or execution time of the determination, in particular of sequences of actual values of the sensor signal 105. In addition or as an alternative thereto, the determination device 110 is designed according to an exemplary embodiment to determine the complex twiddle factors 145 from the available complex twiddle factors 145 by means of interpolation and/or by using geometric identities.

According to an exemplary embodiment, the performing device 120 is designed to perform the fast Fourier transform as a transformation and/or as an inverse transformation. Expressed differently, the performing device 120 is embodied in this case to perform the fast Fourier transform as a transformation from the time domain to the frequency domain or range and/or as an inverse transformation from the frequency domain or range to the time domain. In the transformation, the sensor signal 105 is readable from an interface, in this case the volatile memory 130, to the sensor S and the processed sensor signal 125 contains a discrete Fourier transform. In the case of the inverse transformation, the sensor signal 105 is available in the form of a discrete Fourier transform and the processed sensor signal 125 represents a result of an inverse transformation with conjugate coefficients.

FIG. 2 shows a flowchart of a processing method 200 according to an exemplary embodiment. The method 200 is performable in order to process a sensor signal. Here, the method 200 is performable in conjunction with or using the apparatus of FIG. 1.

In a determination step 210, complex twiddle factors for a fast Fourier transform are determined in the processing method 200. Here, the complex twiddle factors are determined in the determination step 210 using a processing rule, at least a subset of available complex twiddle factors of an overall set of available complex twiddle factors stored in a nonvolatile memory, and at least one signal property derived from the sensor signal. Subsequently, the fast Fourier transform is performed on the sensor signal in a performing step 220 using the complex twiddle factors determined in the determination step 210, in order to provide a processed version of the sensor signal.

In particular, the determination step 210 and the performing step 220 are capable of being carried out in sequentially repeated or continuous fashion.

According to an exemplary embodiment, the processing method 200 also includes a step 205 of storing the overall set of available complex twiddle factors in the nonvolatile memory. Here, the storing step 205 is capable of being carried out at least once before the determination step 210.

FIG. 3 shows a schematic flow diagram of a process 300 according to an exemplary embodiment. The process 300 relates to a fast Fourier transform including the determination of twiddle factors. The process 300 is connected to the method of FIG. 2.

A first block 302 represents a fast Fourier transform (FFT). An input arrow 304 for the FFT represents complex values of length N. A first arrow 306 within the scope of the FFT represents conditions, more precisely groups:=2\hat{ }1 and butterfly graphs:=2\hat{ }(k−1−1). A second block 308, which follows the first arrow 306, represents a first loop with a number k of iterations [k iterations]. A third block 310 is arranged within the second block 308 or the first loop, said third block representing a second loop for groups [groups]. A second arrow 312 which represents an acquisition of twiddle factors is arranged in the third block 310 or the second loop. An explanation block 314 which represents a use of an alternative increment to a maximum FFT length for a current FFT length is associated with the second arrow 312. Further, a fourth block 316 which represents a third loop for butterfly graphs [butterfly graphs] is arranged within the third block 310 or the second loop. A complex butterfly graph is calculated a third arrow 318, which is arranged in the fourth block 316 or the third loop. A fourth arrow 320 is arranged within the second block 308 or the first loop, but outside of the third block 310 or the second loop. The fourth arrow 320 represents conditions, more precisely groups=groups*2 and butterfly graphs=butterfly graphs/2. An output arrow 322 for the FFT represents a complex FFT of length N.

FIG. 4 shows a schematic diagram 400 for twiddle factors 145 according to an exemplary embodiment. The twiddle factors 145 are complex twiddle factors. The twiddle factors 145 are used, in particular, in the apparatus of FIG. 1 and/or in the method of FIG. 2. More precisely, the twiddle factors 145 are the complex available twiddle factors 145. The schematic diagram 400 is represented in the form of a pointer model. Here, the imaginary part Im is plotted on the abscissa axis, with the ordinate axis plotting the real part Re. The twiddle factors 145 are plotted as pointers.

Purely by way of example, a first pointer 441 and a second pointer 442 of the pointers are labeled in more detail. The second pointer 442 represents N₂ twiddle factors

$${e}^{i 2 π \frac{n}{{N}_{2}}} ,$$

n=0, . . . , N₂. The first pointer 441 represents

$${N}_{1} = \frac{{N}_{2}}{2}$$

twiddle factors

$${e}^{i 2 π \frac{n}{{N}_{1}}} = {e}^{i 2 π \frac{2 n}{{N}_{2}}} , n = 0 , … , \frac{{N}_{2}}{2} .$$

With reference to the figures described above, exemplary embodiments of the present invention and principles of exemplary embodiments are briefly explained below in a summarized fashion and using different words.

The method 200 is suitable for computing cores or digital signal processors connected to volatile memory 130 and nonvolatile memory 140 for calculating the discrete Fourier transform from the original domain to the image or the inverse transformation from the image to the original domain for sequences [symbol] _{N}={x(0), . . . , x(N−1)} in the original domain of length N=2^{M}, where M is a positive integer. The discrete Fourier transform has the formula

$$X ( k ) = {\sum }_{n = 0}^{N - 1} x ( n ) {e}^{i 2 π \frac{n k}{N}} = {\sum }_{n = 0}^{N - 1} x ( n ) {W}_{N}^{n k}$$

with the values

$${W}_{N}^{p} = {e}^{i 2 π \frac{p}{N}}$$

denoted as twiddle factors. For a fast Fourier transform of a sequence X_{N} of length N=2^{M},

$$\frac{N}{2}$$

complex twiddle factors W_{N}^{p} with p=0, . . . ,

$$\frac{N}{2} - 1$$

are required.

If such twiddle factors are stored in the nonvolatile memory 140, this reduces a computational outlay for the twiddle factors

$${W}_{N}^{p} = cos ( 2 π \frac{p}{N} ) + i \cdot sin ( s π \frac{p}{N} )$$

for respectively required evaluations of the trigonometric functions. In particular, the method 200 is based on the exploitation of the formula for the twiddle factors, by virtue of all

$$\frac{{N}_{max}}{2}$$

complex twiddle factors 145 W_{N}_{ₘₐₓ}^{p}, p=0, . . . ,

$$\frac{{N}_{max}}{2} - 1 ,$$

for the maximum required length Nₘₐₓ=2^{M}^{ₘₐₓ} being stored in the nonvolatile memory 145. To calculate Fourier transforms for sequences [symbol] _{R} of length R=Nₘₐₓ·2^{-M}, where M is a positive integer, the

$$\frac{R}{2}$$

complex twiddle factors 115

$${W}_{R}^{p} , p = 0 , … , \frac{R}{2} - 1 ,$$

are determined from the

$$\frac{{N}_{max}}{2}$$

complex twiddle factors 145 W_{N}_{ₘₐₓ}^{p}, p=0, . . . ,

$$\frac{{N}_{max}}{2} - 1 ,$$

by way of W_{R}^{p}=

$${W}_{{N}_{ma x}}^{p \frac{{N}_{ma x}}{R}} .$$

In an advantageous implementation, it is possible to adapt the increment for the access to the elements of the sequence of the twiddle factors at runtime. Hence, the required twiddle factors need not be calculated at runtime, or only a subset of the

$$\frac{{N}_{m ax}}{2}$$

complex twiddle factors 145 W_{N}_{ₘₐₓ}^{p}, p=0, . . . ,

$$\frac{{N}_{m ax}}{2} - 1 ,$$

need be created in the volatile memory 130 (RAM), or multiple twiddle factors need not be kept available for different lengths of sequences, and hence it is possible to save storage space or area of integrated circuits.

In the case of an implementation in size-restricted integrated circuits (ASICs), an area required to keep available the twiddle factors 145 can be further reduced by way of storing the twiddle factors 145 in the nonvolatile memory 140 (ROM) in advance.

Dividing the data into volatile and nonvolatile values allows an advantageous reduction in the power consumption by the proposed implementation since read processes for the twiddle factors from the nonvolatile memory 140 require less consumption of power than read processes from the volatile memory 130. An overall power consumption is benefited by storing program code or the processing rule 147 and the twiddle factors 145 in the nonvolatile memory 140.

For the transformation or inverse transformation for sequences of length R=Nₘₐₓ·2^{M}, where M is a positive integer, the calculation of the twiddle factors 115 required in that case from the already available twiddle factors 145 can be implemented by interpolation or by exploiting trigonometric identities in a further advantageous implementation.

What is advantageous about the approach presented here is that a standard computing core can be used, the memory for twiddle factors can be RAM or ROM, and the target application is audio signal processing or processing of other analog signals.

If an exemplary embodiment has an “and/or” conjunction between a first feature and the second feature, this should be read to the effect of the exemplary embodiment having both the first feature and the second feature according to one embodiment and having either only the first feature or only the second feature according to a further embodiment.

1. A method for processing a sensor signal, the method comprising:
determining complex twiddle factors for a fast Fourier transform, the complex twiddle factors being is determined using (i) a processing rule, (ii) at least a subset of available complex twiddle factors of an overall set of available complex twiddle factors stored in one of a nonvolatile memory and a volatile memory, and (iii) at least one configuration derived from a property of the sensor signal; and
performing the fast Fourier transform on the sensor signal using the determined complex twiddle factors to provide a processed version of the sensor signal.

2. The method as claimed in claim 1, wherein the processing rule is used in the determining of the complex twiddle factors is according to the relationship
$${W}_{N}^{p} = cos ( 2 π \frac{p}{N} ) + i \cdot sin ( 2 π \frac{p}{N} )$$
for a fast Fourier transform of a sequence [symbol] _{N} of possible values of the sensor signal with a maximum required length Nₘₐₓ=2^{M}^{ₘₐₓ}, where M is a positive integer, using the overall set of
$$\frac{{N}_{m ax}}{2}$$
available complex twiddle factors W_{N}_{ₘₐₓ}^{p}, p=0, . . . ,
$$\frac{{N}_{m ax}}{2} - 1 ,$$
to facilitate for sequences [symbol] _{R} of actual values of the sensor signal of length R=Nₘₐₓ·2^{-M} the determining of the
$$\frac{R}{2}$$
complex twiddle factors W_{R}^{p}, p=0, . . . ,
$$\frac{R}{2} - 1 ,$$
from the
$$\frac{{N}_{m ax}}{2}$$
available complex twiddle factors W_{N}_{ₘₐₓ}^{p}, p=0, . . . ,
$$\frac{{N}_{max}}{2} - 1 ,$$
according to the relationship
$${W}_{R}^{p} = {W}_{{N}_{ma x}}^{p \frac{{N}_{ma x}}{R}} .$$

3. The method as claimed in of claim 1 further comprising:
storing the overall set of available complex twiddle factors in the one of the nonvolatile memory and the or volatile memory.

4. The method as claimed in claim 1, the performing the fast Fourier transform further comprising:
performing a transformation from a time domain to a frequency domain, the sensor signal being is readable from an interface to a sensor, the processed version of the sensor signal containing a discrete Fourier transform.

5. The method as claimed in claim 1, the performing the fast Fourier transform further comprising:
performing an inverse transformation from a frequency domain to a time domain, the sensor signal representing a Fourier transform of the sensor signal, the processed version of the sensor signal representing an inverse transformation with conjugate coefficients.

6. The method as claimed in claim 1, the determining complex twiddle factors further comprising:
setting an increment for access to the subset of available complex twiddle factors at a runtime of the method.

7. The method as claimed in claim 1, the determining complex twiddle factors further comprising:
determining the complex twiddle factors from the subset of available complex twiddle factors using at least one of interpolation and geometric identities.

8. An apparatus for processing a sensor signal, the apparatus comprising:
a determination device configured to determine complex twiddle factors for a fast Fourier transform, the complex twiddle factors being determined using (i) a processing rule, (ii) at least a subset of available complex twiddle factors of an overall set of available complex twiddle factors stored in one of a nonvolatile memory and a volatile memory, and (iii) at least one configuration derived from a property of the sensor signal; and
a performance device configured to perform the fast Fourier transform on the sensor signal using the determined complex twiddle factors to provide a processed version of the sensor signal.

9. The method as claimed in claim 1, wherein the method is carried out by a computer program.

10. A non-transitory machine-readable storage medium that stores a computer program that, when executed, causes an apparatus to:
determine complex twiddle factors for a fast Fourier transform, the complex twiddle factors being determined using (i) a processing rule, (ii) at least a subset of available complex twiddle factors of an overall set of available complex twiddle factors stored in one of a nonvolatile memory and a volatile memory, and (iii) at least one configuration derived from a property of the sensor signal; and
perform the fast Fourier transform on the sensor signal using the determined complex twiddle factors to provide a processed version of the sensor signal.
